(19) United States
(12) Patent Application Publication
(10) Pub. No.: US 2014/0352938 A1
(43) Pub. Date: Dec. 4, 2014

(54) EGR COOLER HEADER DESIGN

(71) Applicants: Bashar Y. Melhem, Orland Park, IL (US); Luis Carlos Cattani, Aurora, IL (US); Martin R. Zielke, Homer Glen, IL (US)

(72) Inventors: Bashar Y. Melhem, Orland Park, IL (US); Luis Carlos Cattani, Aurora, IL (US); Martin R. Zielke, Homer Glen, IL (US)

(73) Assignee: International Engine Intellectual Property Company LLC, Lisle, IL (US)

(21) Appl. No.: 14/356,198

(22) PCT Filed: Apr. 16, 2012
(86) PCT No.: PCT/US2012/033787

§ 371 Date: May 5, 2014

Related U.S. Application Data
(60) Provisional application No. 61/555,203, filed on Nov. 3, 2011.

(51) Int. Cl. F02M 25/07; F28D 7/00

(52) U.S. Cl. CPC F02M 25/07; F28D 7/00
USPC 165/173

(57) ABSTRACT

A heat exchanger having a modified header design for absorbing high thermal loads, is described. The heat exchanger includes a housing having an interior space, a core within the interior space of the housing, the core comprising a plurality of flow passages, and a header positioned at an end of the housing and in communication with the core, wherein the header includes a thermal absorbing formation. The thermal absorbing formation may take the form of a continuous raised rib around an inner circumference of the header. The raised rib absorbs excess heat and reduces thermal strain on the heat exchanger.

### TECHNICAL FIELD

The present device relates to a heat exchanger for use in internal combustion engines. Particularly, the present device relates to an exhaust gas recirculation (EGR) cooler having modified header design for absorbing higher thermal loads resulting from increased exhaust flow through the EGR cooler in order to increase the reduction of NO in the exhaust stream.

### BACKGROUND

Diesel engines are efficient, durable and economical. Diesel exhaust, however, can harm both the environment and people. To reduce this harm, governments, such as the United States and the European Union, have proposed stricter diesel exhaust emission regulations. These environmental regulations require diesel engines to meet the same pollution emission standards as gasoline engines. Typically, to meet such regulations and standards, diesel engine systems require equipment additions and modifications.

For example, a lean burning engine provides improved fuel efficiency by operating with an amount of oxygen in excess of the amount necessary for complete combustion of the fuel. Such engines are said to run “lean” or on a “lean mixture.” However, the increase in fuel efficiency is offset by the creation of undesirable pollution emissions in the form of nitrogen oxides (NOₓ). Nitrogen oxide emissions are regulated through regular emission testing requirements.

Many internal combustion engines use an exhaust gas recirculation (EGR) system to reduce the production of NOₓ during the combustion process in the cylinders. EGR systems typically divert a portion of the exhaust gases exiting the cylinders for mixing with intake air. The exhaust gas generally lowers the combustion temperature of the fuel below the temperature where nitrogen combines with oxygen to form NOₓ. EGR systems have an EGR cooler or heat exchanger that reduces the temperature of the exhaust gases. Generally, more exhaust gas can be mixed with the intake air when the exhaust gas temperature is lower. Additional exhaust gases in the intake air may further reduce the amount of NOₓ produced by the engine.

EGR coolers typically use coolant from the engine's cooling system to reduce the temperature of the exhaust gases. The coolant may be water, an antifreeze fluid such as ethylene glycol, a combination thereof, or the like. The EGR cooler is connected to another engine component in series so that the same coolant flows through the other component and then the EGR cooler in sequence. The EGR cooler includes a plurality of internal tubes or conduit providing a pathway for flow of exhaust gases through the cooler. As the exhaust gases flow through the tubes, excess heat is released into circulating coolant thereby reducing the temperature of the exhaust gases and the formation of NOₓ.

With more stringent emission regulations comes the need to increase EGR flow rates. Increasing flow rates challenge the robustness of the EGR cooler to absorb higher thermal loads and reduces the life of the EGR cooler. However, increased thermal loads may cause the EGR header to deform, which in turn, may weaken the tube to header junction and shorten the life of the EGR cooler. In an effort to counteract the thermal increase, a modified header is proposed to absorb thermal loads before it reaches the sensitive tube to header junction. Thus, in the present disclosure, a modified header will include a raised deformation or thermal expansion rib, which is designed to absorb the thermal loads away from the tube to header junction.

Therefore, an EGR cooler with a modified header design to counteract any increase in thermal loads resulting from increases in exhaust flow through the EGR cooler, is described. The modified header provides a cost-effective solution because it does not require a change in design or major modification to the EGR cooler itself. Furthermore, the modified header design results in an increase of the thermal life of the EGR cooler.

### SUMMARY

There is disclosed herein a device, which avoids the disadvantages of prior devices while affording additional operating advantages.

Generally speaking, a heat exchanger, such as an EGR cooler having a modified header design for absorbing high thermal loads, is described and claimed.

In an embodiment, a heat exchanger for use in reducing the production of NOₓ in an exhaust stream, is disclosed. The heat exchanger comprises a housing having an interior space, a core within the interior space of the housing, the core comprising a plurality of flow passages, and a header positioned at an end of the housing and in communication with the core, wherein the header includes a thermal absorbing formation.

In an embodiment, the thermal absorbing formation is a continuous raised rib around an inner circumference of the header.

In yet another embodiment, the thermal absorbing formation is a sectional raised rib around an inner circumference of the header.

In yet a further embodiment, an EGR cooler for use in reducing the production of NOₓ in an exhaust stream, is disclosed. The cooler comprises a housing having an interior space for receiving a core having at least a first flow passage and a second flow passage, and a header positioned at an end of the housing, the header connected to the first flow passage by at least one joint, wherein the header includes a thermal expansion rib for absorbing excess heat from reaching the joint.

These and other aspects of the present device may be understood more readily from the following description and the appended drawings

### BRIEF DESCRIPTION OF THE DRAWINGS

FIG. 1 is an embodiment of a prior art header design;

FIG. 2 is a perspective view of an EGR cooler with an embodiment of the present modified header design;

FIG. 3 is sectional view of FIG. 3 taken along lines A-A;

FIG. 4 is a side view showing the tube-to-header joint of the EGR cooler;

FIG. 5 is a front view of an embodiment of the present modified header design;

FIG. 6 is a rear view of an embodiment of the present modified header design; and,

FIG. 7 is another embodiment of the modified header design.

### DETAILED DESCRIPTION

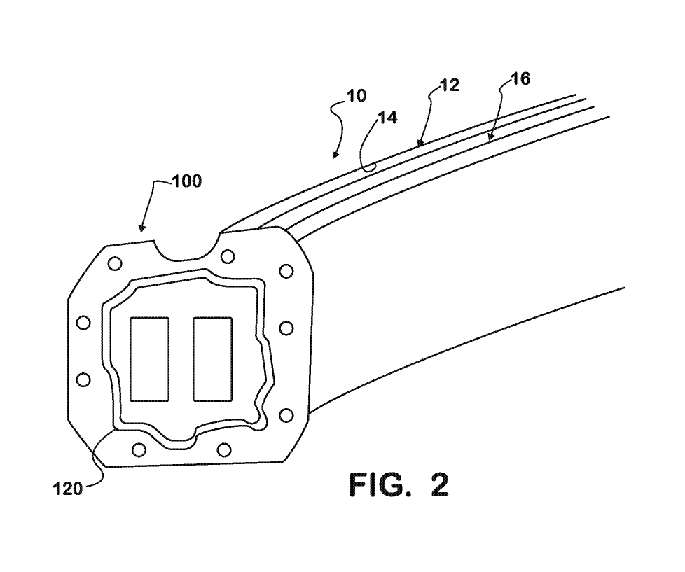

Referring to FIGS. 2-7, there is illustrated a heat exchanger, generally designated 10, having a modified header 100. The heat exchanger may be an EGR cooler. As generally know, hot exhaust flow enters into the heat exchanger from the exhaust manifold (not shown) near the turbocharger (not shown) of an engine (not shown). By circulating a coolant, or cooling fluid through the heat exchanger 10 through a series of passageways, and over a plurality of baffles, the hot exhaust gases (flowing through a passageway separate from the coolant) are cooled to a temperature that will not adversely impact combustion efficiency. The cooled gases are returned to the intake manifold (not shown) through an EGR valve (not shown), which opens and closes based on operating conditions. Reducing the temperature of the exhaust gases diminishes the amount of NOₓ produced in the exhaust stream.

Heat exchangers and EGR coolers are typically comprised of a casing or housing 12 having an interior 14 for receiving a core 16. The housing 12 also includes an inlet (not shown) for receiving a cooling fluid into the interior space, and outlet (not shown) for releasing the cooling fluid from the interior space. The housing 12 can have any suitable shape depending on vehicle requirements, but is typically elongated, having a length sufficient for adequate coolant flow and heat dissipation from the exhaust stream.

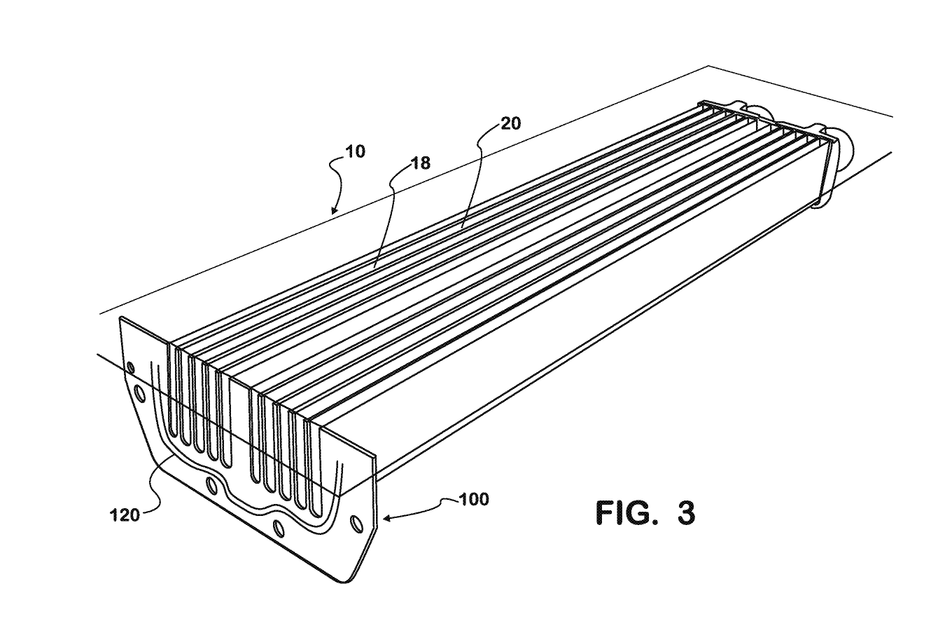

The core 16 is made up of a plurality of passageways, which are separate for the coolant and the exhaust gases. For example, as shown in FIG. 3, the core includes a first flow passage 18 including a plurality of tubes or conduits for receiving exhaust gas. In addition, the core 16 includes a second flow passage 20 comprising a plurality of passageways between the tubes for receiving a cooling fluid. The second flow passage 20 can includes a series of baffles (not shown), which direct the flow of coolant through the passage. It should be understood that the first flow passage and second flow passage can include a variety of configurations (for example, straight, curved or angled) and arrangements to one another within the housing, depending on the ultimate design of the EGR cooler and the cooling requirements of the system in which it is being used.

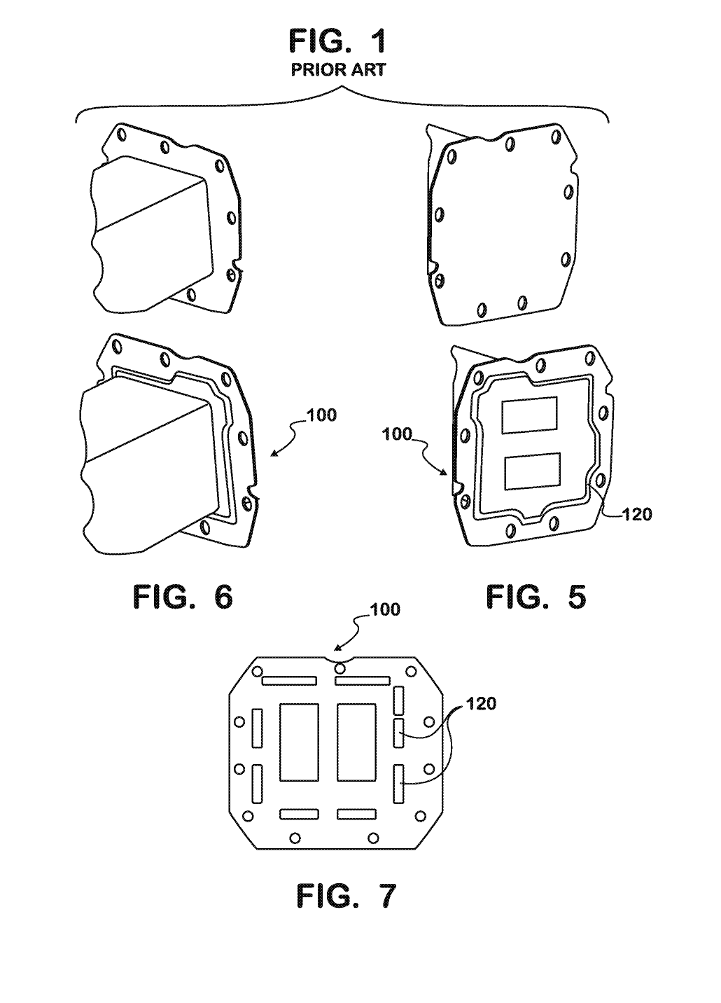

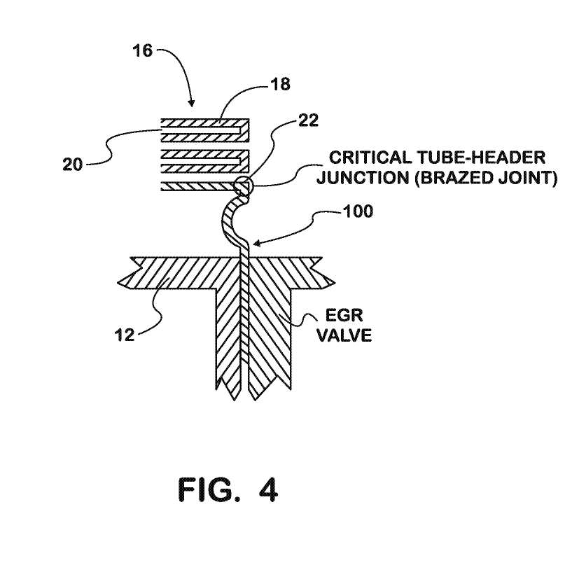

Additionally, the EGR cooler 10 includes at least one header 100. When the header 100 is attached to the cooler housing 12 in a known manner, for example, by welding. The tubes or conduits 18 within the housing 12 are likewise connected to the header 100 by brazing, forming a joint 22 between the tube and the header, which carry the exhaust flow through the core 16 (FIG. 4). However, the tube-to-header joint 22 can become weakened with excess thermal load if the header deforms due to its configuration. In particular, as shown in FIG. 1, prior art headers are generally made from fine-blanked or machine formed cast metal, such as stainless steel, and have a “flat” configuration. When exposed to high thermal loads, these flat headers have a tendency to deform and transfer the excess thermal load to the juncture where the exhaust passageways and the header meet, resulting in possible failure of the header and juncture.

In an effort to avoid possible thermal deformation and a weakened tube-to-header joint 22, a modified header design is described. FIGS. 5 and 6 illustrate one embodiment of the modified header 100, while FIG. 7 represents another possible embodiment of the modified header. The modified header 100 includes a thermal absorbing formation or thermal expansion rib 120, which in one embodiment, is configured as a continuous raised structure. The thermal absorbing formation 120 may have various shapes depending the configuration of the header itself. In addition, the thermal absorbing formation 120 may be continuous around the inner circumference of the header 100, as shown in FIG. 5, or alternatively, may be formed as sections, as shown in FIG. 7. It should be understood that the embodiments in the present disclosure are for illustrative purposes only, and that the structure of the thermal absorbing formation or thermal expansion rib and its placement on the header can vary depending on system requirements.

Regardless of the specific configuration, the thermal absorbing formation or thermal expansion rib 120, serves the function of absorbing thermal load, therefore reducing the amount of deformation in the header 100. Eliminating or reducing the header deformation will reduce the effect the deformation may have on the sensitive tube-to-header joint 22, thus extending the life of the EGR cooler.

What is claimed is:

1. A heat exchanger for use in reducing the production of NOₓ in an exhaust stream, the heat exchanger comprising:
a housing having an interior space;
a core within the interior space of the housing, the core comprising a plurality of flow passages; and,
a header positioned at an end of the housing and in communication with the core, the header including a thermal absorbing formation within the header.

2. The heat exchanger of claim 1, wherein the flow passages comprise a first flow passage and a second flow passage

3. The heat exchanger of claim 2, wherein the first flow passage comprises a plurality of tubes for receiving exhaust gas.

4. The heat exchanger of claim 3, wherein the tubes contact the header at a brazed joint.

5. The heat exchanger of claim 4, wherein the thermal absorbing formation diverts excess thermal load from the brazed joint.

6. The heat exchanger of claim 2, wherein the second flow passages comprises a plurality of passageways between the tubes for receiving a cooling fluid.

7. The heat exchanger of claim 1, wherein the thermal absorbing formation is a continuous raised rib around an inner circumference of the header.

8. The heat exchanger of claim 1, wherein the thermal absorbing formation is a sectional raised rib around an inner circumference of the header.

9. The heat exchanger of claim 1, wherein the thermal absorbing formation absorbs excess thermal load to the header.

10. An EGR cooler for use in reducing the production of NOₓ in an exhaust stream, the cooler comprising:
a housing having an interior space for receiving a core having at least a first flow passage and a second flow passage;
a header positioned at an end of the housing, the header connected to the first flow passage by at least one joint, wherein the header includes a thermal expansion rib within the header for absorbing excess heat from reaching the joint.

11. The EGR cooler of claim 10, wherein the first flow passage comprises a plurality of tubes for receiving exhaust gas.

12. The EGR cooler of claim 10, wherein the thermal expansion rib minimizes thermal strain at the first flow passage to header joint.
